(19) United States
(12) Patent Application Publication
(10) Pub. No.: US 2026/0336116 A1
(43) Pub. Date: Oct. 29, 2026

(54) ADJUSTMENT DEVICE

(71) Applicant: FANUC CORPORATION, Yamanashi (JP)

(72) Inventor: Satoshi INAGAKI, Yamanashi (JP)

(73) Assignee: FANUC CORPORATION, Yamanashi (JP)

(21) Appl. No.: 19/117,595

(22) PCT Filed: Oct. 18, 2022
(86) PCT No.: PCT/JP2022/038669

§ 371 Date: Apr. 1, 2025

(51) Int. Cl. B25J 9/16; G05B 17/02

(52) U.S. Cl. CPC B25J 9/1671; B25J 9/1664; G05B 17/02

(57) ABSTRACT

The present invention provides a technology capable of improving work efficiency by facilitating adjustment of the weight of each evaluation function for controlling the motion of a robot. An adjustment device 10 adjusts an evaluation function for generating the trajectory of a robot 2 under a prescribed constraint condition. The adjustment device 10 comprises: a trajectory information acquisition unit 14 that acquires trajectory information that pertains to the trajectory of the robot 2 and is specified by a user; and a weight setting unit 15 that sets, on the basis of the trajectory information specified by the user, a weight Wᵢ of an evaluation function for generating the trajectory of the robot 2.

### TECHNICAL FIELD

The present disclosure relates to an adjustment device that adjusts an evaluation function for generating a path of a robot under a prescribed constraint condition.

### BACKGROUND ART

Conventionally, a technology for controlling the motion of a robot by setting an evaluation function that uses the path of a working part of a robot such as an manipulator, as a variable, and optimizing the evaluation function under a restriction condition such as no interference with surrounding objects has been known (see, for example, Patent Document 1 and Patent Document 2). Examples of the evaluation function of this type may include cycle time, power consumption, and clearance and jerk with respect to surrounding objects.

### CITATION LIST

### Patent Document

Patent Document 1: Japanese Unexamined Patent Application, Publication No. H10-249761
Patent Document 2: Japanese Unexamined Patent Application, Publication No. H5-228860

### DISCLOSURE OF THE INVENTION

### Problems to be Solved by the Invention

In practice, instead of using a single evaluation function, a linear sum of a plurality of evaluation functions may be used as an evaluation function to improve effectiveness. In general, desired motions differ depending on each user and each application, which makes it necessary to adjust the weight of each evaluation function. However, it is not intuitively clear what kind of robot motion is generated when the weight of each evaluation function is varied. Therefore, the work of repeating weight adjustment is necessary to produce the desired motion, and this takes time and effort.

Even in the conventional technology, the processing of optimizing the weight of each evaluation function is known. However, since an optimal value varies for each user, a single fixed weight is not sufficient, and adjustment suitable for each user becomes necessary after all. For example, there is a description in Patent Document 1 that several types of spray routes are displayed for a user to select a desired route. However, this is merely for dealing with variations in the result of each spray route operation caused by the stochastic nature of weight optimization methods, and does not mean that the weight for each user is applied. There is room for improvement in the conventional technology in terms of facilitating adjustment of the weight suitable for each user.

The present disclosure has been made in view of the above issue, and an object of the present disclosure is to provide a technology capable of improving work efficiency by facilitating adjustment of the weight of each evaluation function for controlling the motion of a robot.

### Means for Solving the Problems

The present disclosure relates to an adjustment device that adjusts an evaluation function for generating a path of a robot under a prescribed constraint condition, the adjustment device including: a path information acquisition unit that acquires path information that relates to the path of the robot and is specified by a user; and a weight setting unit that sets, based on the path information specified by the user, a weight of an evaluation function for generating the path of the robot.

### Effects of the Invention

The present disclosure can provide a technology capable of improving work efficiency by facilitating adjustment of the weight of an evaluation function for controlling the motion of a robot.

### BRIEF DESCRIPTION OF THE DRAWINGS

FIG. 1 is a schematic view showing the configuration of a robot control system according to a first embodiment of the present invention;

FIG. 2 is a functional block diagram of a control device for a robot according to the first embodiment;

FIG. 3 is a diagram illustrating a method of setting an evaluation function for generating a path in the first embodiment;

FIG. 4 is a diagram illustrating a method of setting a weight of the evaluation function in the first embodiment;

FIG. 5 is a diagram illustrating the relationship between a plurality of user programs and the weight in the first embodiment;

FIG. 6 is a flowchart showing an example of the flow of processing by the control device for the robot according to the first embodiment;

FIG. 7 is a diagram illustrating a method of setting the weight of the evaluation function in a second embodiment; and

FIG. 8 is a flowchart showing an example of the flow of processing by the control device for the robot according to the second embodiment.

### PREFERRED MODE FOR CARRYING OUT THE INVENTION

Hereinafter, embodiments of the present disclosure will be described in detail with reference to the drawings. Note that in the description of second and subsequent embodiments, component members similar to those in the first embodiment are designated by identical reference numerals to omit the description thereof.

### First Embodiment

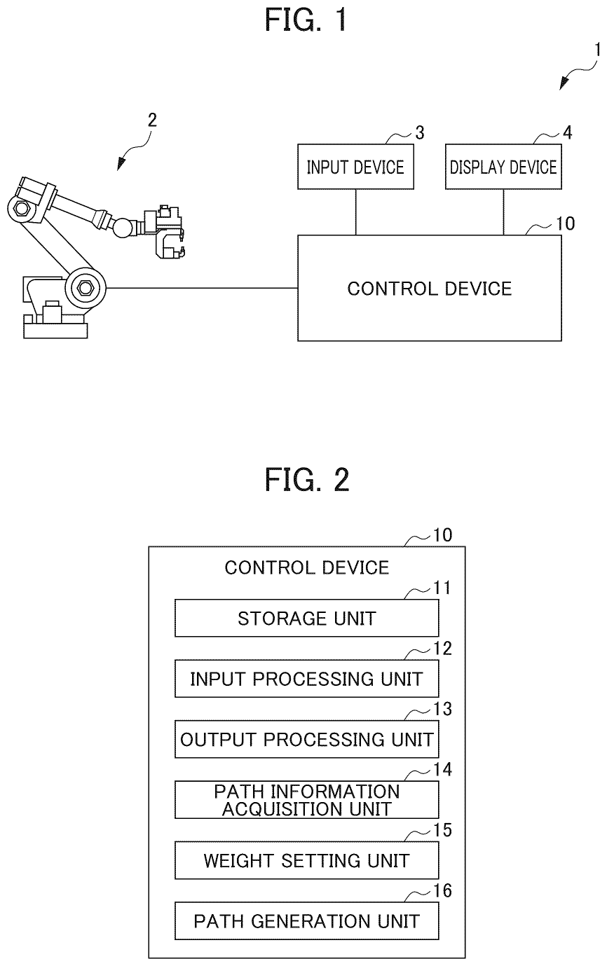

FIG. 1 is a schematic view showing the configuration of a robot control system 1 according to a first embodiment of the present invention. As shown in FIG. 1, the robot control system 1 includes a robot 2, an input device 3, a display device 4, and a control device 10 as main components. The present embodiment is an example in which an adjustment device of the present disclosure is applied to the control device 10.

For example, the robot 2 is an articulated robot, such as a 6-axis vertical articulated robot or a 4-axis vertical articulated robot. The robot 2 is electrically connected to the control device 10 and operates based on information input from the control device 10. Note that the robot 2 is not limited to the articulated robot, and may be a Cartesian coordinate robot, a SCARA robot, a parallel link robot, or the like.

The input device 3 is an interface that receives information relating to work performed by the robot 2 and control of the robot 2. The input device 3 is constituted of, for example, a keyboard or a touch panel, and outputs input information based on input operation of a user to the control device 10.

The display device 4 is an output device that outputs information relating to the work performed by the robot 2 and information relating to the control of the robot 2. The display device 4 is constituted of, for example, a display, a display with a speaker function, or the like, and displays an image based on the information input from the control device 10. The display device 4 may be constituted of a touch panel display that is configured integrally with the input device 3.

The control device 10 is constituted using a computer including memory, such as a read only memory (ROM) and a random access memory (RAN), a control processing unit (CPU), and a communication control unit, which are connected to each other via a bus. The functions and operations of each functional unit of the control device 10 described below are achieved through cooperation of the CPU, the memory, and control programs stored in the memory, which are installed in the above-mentioned computer. Note that the control device 10 may be configured to control the robot 2 based on the information input from an external computer.

Description is now given of a function of generating path, among the control functions of the control device 10 that relate to the motions of the robot in the present embodiment. FIG. 2 is a functional block diagram of the control device 10 for the robot 2 according to the present embodiment. As shown in FIG. 2, the control device 10 includes a storage unit 11, an input processing unit 12, an output processing unit 13, a path information acquisition unit 14, a weight setting unit 15, and a path generation unit 16 as functional units.

The storage unit 11 stores various types of information, such as programs for operating the robot 2, information relating to the work, motion, or the like of the robot 2, and information for displaying images indicating various types of information on the display device 4.

The input processing unit 12 executes processing to acquire user operation information received through the input device 3.

The output processing unit 13 executes processing to display on the display device 4 images indicating various types of information generated in the control device 10.

The path information acquisition unit 14 acquires path information that relates to the path specified by the user and is stored in the storage unit 11. In the first embodiment, the path information is a user program.

The weight setting unit 15 sets the weight of an evaluation function based on the program acquired by the path information acquisition unit 14. The evaluation function is for generating the path of the robot 2 under a prescribed constraint condition. Examples of the constraint condition include evaluation items that constrain the path of the robot 2, such as no interference with surrounding objects (for example, distance to the surrounding objects being a constant value or more), movement speed of the robot being a prescribed speed a or less, an allowable load of the robot 2, and power consumption. Note that the method of setting the weight by the weight setting unit 15 in the present embodiment will be described later.

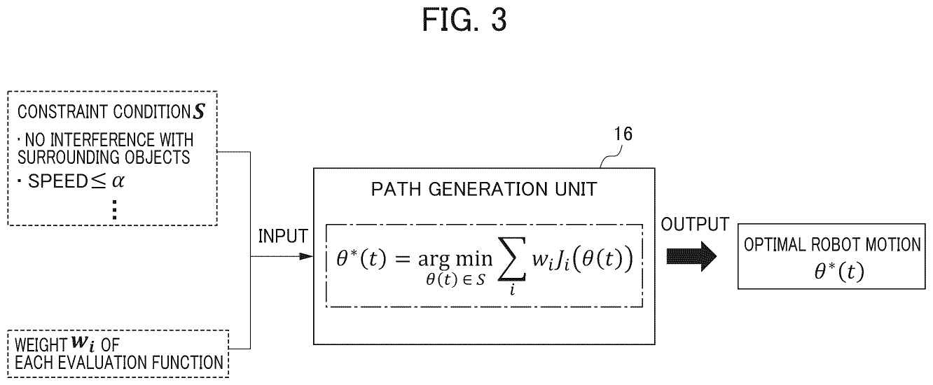

Description is now given of the path generation unit 16 with reference to FIG. 3. FIG. 3 is a diagram illustrating a method of setting an evaluation function for generating a path in the first embodiment. As shown in FIG. 3, the path generation unit 16 sets an evaluation function for generating the path based on a plurality of constraint conditions S and a weight Wᵢ of each function set by the weight setting unit 15.

The evaluation function is expressed by the following expression (1), for example. The expression (1) is the same as an expression used by the path generation unit 16 in FIG. 3. In the expression (1), S represents a set of the above-mentioned constraint conditions, Wᵢ represents the weight set for each evaluation function that indicates constraint conditions, and Jᵢ represents, for example, cycle time, clearance to surrounding objects, a maximum jerk value, and an integral value of jerk. According to the expression (1), parameters are set to minimize a linear sum of the evaluation functions indicating the constraint conditions, so that an optimal robot motion is derived.

$$\begin{matrix}[ Expression 1 ] & \\ {θ}^{*} ( t ) = {arg}_{θ ( t )} {min}_{∈ S} {\sum }_{i} {w}_{i} {J}_{i} ( θ ( t ) ) & Expression 1\end{matrix}$$

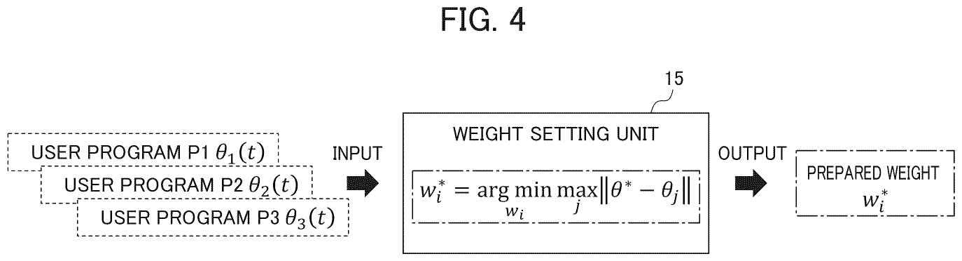

Next, a method of setting a weight in the first embodiment will be described. FIG. 4 is a diagram illustrating a method of setting a weight of the evaluation function in the first embodiment. As shown in FIG. 4, the weight setting unit 15 optimizes the weight Wᵢ of the evaluation function by using a plurality of user programs P1 to P3 as the path information. The user programs P1 to P3 are the programs actually used by the user and are the information relating to the path.

For example, the weight setting unit 15 optimizes the weight Wᵢ using the following expression (2). The expression (2) is the same as an expression used by the weight setting unit 15 in FIG. 4. As shown in the expression (2), the weight setting unit 15 sets the weight of the evaluation function so as to minimize the difference between the path (θ*) based on each of the user programs P1 to P3 and the path (θⱼ) generated based on the evaluation function. Note that the difference between the paths (θ*) of the user programs P1 to P3 and the path (θⱼ) generated by the evaluation function is calculated based on a maximum possible value. In other words, the weight Wᵢ is optimized so as to minimize error under the worst condition.

$$\begin{matrix}[ Expression 2 ] & \\ {w}_{i}^{*} = arg {min}_{{w}_{i}} {max}_{j} ‖ {θ}^{*} - {θ}_{j} ‖ & Expression 2\end{matrix}$$

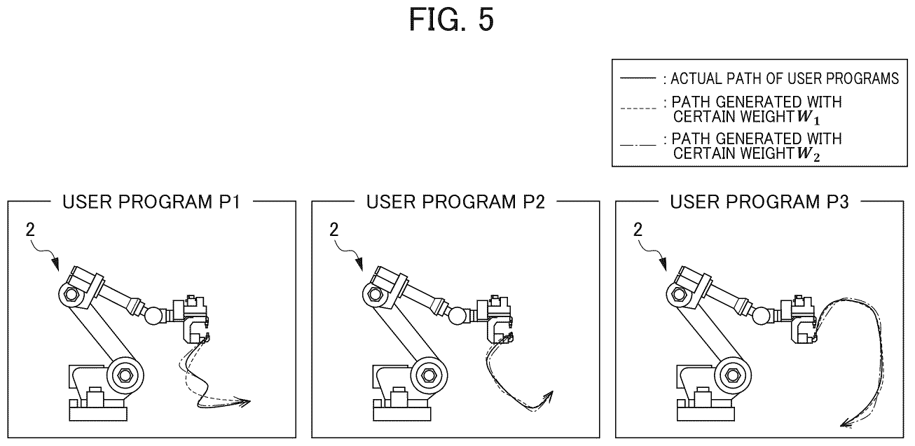

FIG. 5 is a diagram illustrating the relationship between the user programs P1 to P3 and the weight Wᵢ in the first embodiment. FIG. 5 shows actual paths based on the respective user programs P1 through P3 by solid lines. The actual path based on the user program P1 is the path generated based on a function θ₁(t) in FIG. 4. Similarly, the actual path based on the user program P2 is the path generated based on a function θ₂(t), and the actual path based on the user program P3 is the path generated based on a function θ₃(t).

FIG. 5 also shows a path, which is generated based on a weight W₁ that is preset under a certain condition, by a dashed line. The weight W₁ is, for example, set to shorten the cycle time as much as possible, and as the cycle time is shorter, more sudden motions increases, which increases load and power consumption of the robot 2. FIG. 5 shows the path, which is generated based on a weight W₂ that is set under a different condition from the weight W₁, by a dashed line. The weight W₂ is set, for example, to reduce the load on the robot 2 as much as possible, and the path of the robot 2 is relatively gradual.

In the example shown in FIG. 5, the path based on the weight W₁ has a large error with respect to the user program P1, and a very small error with respect to the user program P2 and the user program P3. Therefore, a maximum error value is large. On the other hand, since the path based on the weight W₂ has a smaller error with respect to all of the user programs P1 to P3, the maximum error value is smaller than the path based on W₁. Therefore, in the example shown in FIG. 5, the weight W₂ is more appropriate than the weight W₁ as the weight W₁ common to the plurality of user programs P1 to P3.

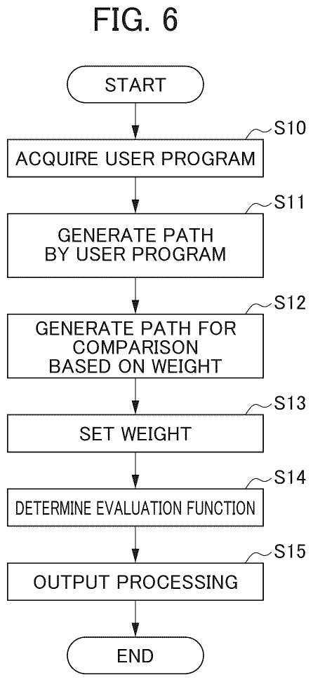

Description is now given of the flow of path generation processing by the control device 10 in the first embodiment. FIG. 6 is a flowchart showing an example of the flow of processing by the control device 10 for the robot 2 according to the first embodiment. Note that the flowchart shown in FIG. 6 is merely an example, and the order of processing or the like is not limited to this example.

When the processing relating to the path generation is started, the path information acquisition unit 14 acquires a plurality of user programs P1 to P3 from the storage unit 11 (Step S10). Then, the path generation unit 16 generates information indicating actual paths based on the user programs P1 to P3 (Step S11). The path generation unit 16 also generates a plurality of paths based on preset weights (Step S12).

The weight setting unit 15 then compares the actual paths based on the user program P1 to P3 and a plurality of paths based on the preset weights to set the weight Wᵢ that minimizes the error (Step S13). The path generation unit 16 then determines the evaluation function based on the weight Wᵢ set by the weight setting unit 15 (Step S14).

The output processing unit 13 outputs information relating to the evaluation function and the weight Wᵢ set by the weight setting unit 15 (Step S15). For example, the output processing unit 13 may output on the display device 4 an indication such as “A new weight common to user programs is set”.

The control device 10 that controls the motion of the robot 2 according to the first embodiment described above demonstrates the following effects. Specifically, the control device 10 for the robot 2 includes the path information acquisition unit 14 that acquires path information that relates to the path of the robot 2 and is specified by a user, and the weight setting unit 15 that sets, based on the path information specified by the user, the weight Wᵢ of an evaluation function for generating the motion of the robot 2. This reduces the time and effort to adjust the weight Wᵢ of the evaluation function, and allows the user to easily obtain the evaluation function that generates the motion of the robot 2 that is considered to be desirable by the user himself or herself, so that the work efficiency for determining the motion of the robot 2 can be improved.

The path information acquisition unit 14 in the first embodiment acquires the plurality of user programs input by the user as the path information, and the weight setting unit 15 sets the weight Wᵢ for the function relating to the constraint condition. As a result, the weight Wᵢ is automatically adjusted in accordance with the program used by the user, and therefore the path can be generated with the weight Wᵢ that is more suitable for an actual work of the robot 2.

The weight setting unit 15 in the first embodiment sets the weight Wᵢ common to all of the plurality of user programs so as to prevent the difference between the paths of the robot 2 based on the plurality of user programs from increasing. This eliminates the need to set the weight for each user program, so that the burden on the user for weight adjustment can effectively be reduced.

The control device 10 in the first embodiment further includes the output processing unit 13 that outputs information that relates to the weight Wᵢ and is set by the weight setting unit 15. This allows the user to make various adjustments relating to the motion of the robot 2 after grasping the information relating to the weight Wᵢ that is set based on the plurality of user programs.

### Second Embodiment

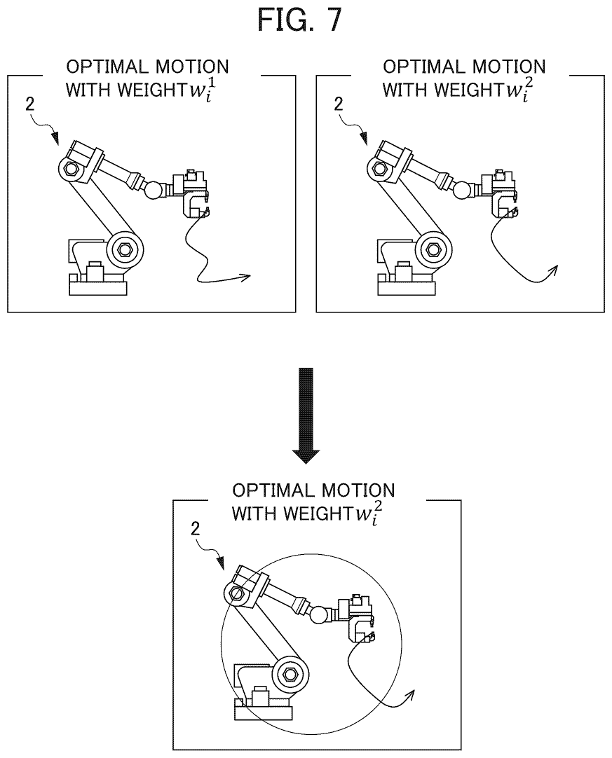

Description is now given of the control device 10 for the robot 2 in a second embodiment. FIG. 7 is a diagram illustrating a method of setting the weight of the evaluation function in the second embodiment. Note that the control device 10 according to the second embodiment is different from the control device 10 for the robot 2 according to the first embodiment in the method of setting the weight and is in common with the first embodiment in other conventional aspects.

In the second embodiment, the storage unit 11 stores information indicating typical application motions, such as motions at the time of handling or spot welding.

As shown in FIG. 7, the path generation unit 16 generates the paths based on a plurality of different weights Wᵢ for an application motion. In other words, the path generation unit 16 performs simulation using a plurality of types of weights for the application motion. As a result, a plurality of paths is generated for the user to select a desired path. In the example shown in FIG. 7, a simulation result for the path using the evaluation function based on the weight Wil and a simulation result for the path using the evaluation function based on a weight Wᵢ² are output.

In the second embodiment, a desired path selected by the user from among the plurality of simulation results is defined as the path information, and the weight is set based on the path information. In the example shown in FIG. 7, the simulation result for the path using the evaluation function based on the weight Wᵢ² is selected as a user's desired motion.

The weight setting unit 15 in the second embodiment sets a new weight Wᵢ₊₁ based on the weight Wᵢ² corresponding to the simulation result specified by the user. For example, the weight setting unit 15 resets a new weight Wᵢ₊₁² based on Wᵢ₊₁¹=Wᵢ²+Δ, and sets a new weight Wᵢ₊₁² based on Wᵢ₊₁²=Wᵢ²−Δ. In this example, the new weight Wᵢ₊₁ to be presented to the user is set by adding or subtracting the weight Wᵢ² corresponding to the result of user selection.

The path generation unit 16 performs simulations again based on the adjusted weights to generate the path of the robot 2 based on Wᵢ₊₁¹ and the path of the robot 2 based on Wᵢ₊₁². The output processing unit 13 then executes the processing to display the path of the robot 2 based on Wᵢ₊₁¹ and the path of the robot 2 based on Wᵢ₊₁² on the display device 4. As a result, user selection is performed again. Thus, user selection and weight adjustment processing are repeated, so that the weight of the evaluation function for generating the path is adjusted to a value more suitable for the user.

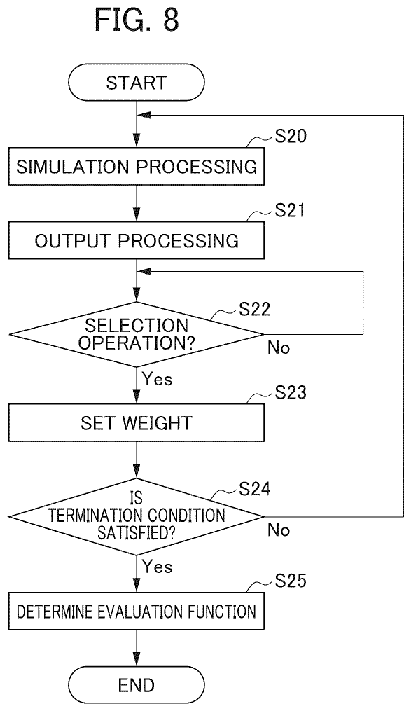

Description is now given of the flow of path generation processing by the control device 10 in the second embodiment. FIG. 8 is a flowchart showing an example of the flow of processing by the control device 10 for the robot 2 according to the second embodiment. Note that the flowchart shown in FIG. 8 is merely an example, and the order of processing or the like is not limited to this example.

When the processing relating to path generation is started, the path generation unit 16 reads typical application motions from the storage unit 11, and executes simulation processing to generate the paths based on a plurality of evaluation functions that are different in setting of the weight Wᵢ for the application motion (Step S20).

Next, the output processing unit 13 performs output processing to display an image on the display device 4 to allow the user to select a plurality of paths generated by simulation processing (Step S21). The input processing unit 12 then waits for the user selection operation to be input through the input device 3 (Step S22). When the user selection operation is input, the input processing unit 12 moves the processing to Step S23 (Step S22; Yes). Note that the input processing unit 12 continues the waiting processing until the user selection result is input (Step S22; No), though the input processing unit 12 may be configured to terminate the processing when a certain period of time has elapsed or when receiving the user operation that instructs cancellation.

In Step S23, as described above, the weight setting unit 15 adjusts the weight Wᵢ based on the user selection operation and sets the new weight Wᵢ₊₁ (Step S23).

The weight setting unit 15 determines whether or not a termination condition is satisfied (Step S24). The exit condition is a pre-set condition to terminate the setting of the weight Wᵢ. The termination condition may be, for example, the case where the input processing unit 12 detects user operation to terminate the weight setting through the input device 3 or the case where the number of times of user selection reaches a prescribed number of times.

When the termination condition is not satisfied, the weight setting unit 15 returns the processing to Step S20 (Step S24; No) to generate the path for the application motion again based on the adjusted weight Wᵢ₊₁. This causes Step S20 and subsequent processing to be repeated again.

In Step S24, when the termination condition is satisfied, the weight setting unit 15 moves the processing to Step S25 (Step S24; Yes). In Step S25, the weight Wᵢ is confirmed, and the evaluation function for generating the path is confirmed.

The control device 10 for the robot 2 according to the second embodiment described above demonstrates the following effects. The control device 10 for the robot 2 according to the present embodiment further includes the output processing unit 13 that outputs a plurality of simulation results for the path of the robot based on a plurality of evaluation functions different in setting of the weight Wᵢ, in which the path information acquisition unit 14 acquires, as the path information, the simulation result specified by the user out of the plurality of output simulation results, and the weight setting unit 15 newly sets a weight Wᵢ of the evaluation function based on the weight Wᵢ of the evaluation function corresponding to the simulation result specified by the user. As a result, even before the user program is input, an intuitive interface that allows specification of the simulation result allows adjustment of the weight for each user.

In the second embodiment, the output processing unit 13 outputs the simulation result of the weight newly set by the weight setting unit 15, and the weight setting unit 15 newly sets a weight of the evaluation function based on the weight of the evaluation function corresponding to the simulation result re-specified by the user. As a result, since a plurality of times of user specification is reflected on the setting of the weight, the weight is set to reflect the user intention more.

Although the present disclosure has been described in detail, the present disclosure is not limited to the embodiments disclosed. Various additions, replacements, modifications, and partial deletions can be made for these embodiments without departing from the gist of the present disclosure or without departing from the conceptual thought of the present disclosure derived from the contents and their equivalents defined in claims. These embodiments can also be carried out in combination. For example, in the above embodiments, the order of each operation and the order of each processing are exemplary and not restrictive. The same applies when numerical values or expressions are used to describe the above embodiments.

For example, in the above embodiments, the adjustment device of the present disclosure is applied to the control device for the robot. However, without being limited thereto, the adjustment device of the present disclosure may be applied to an external computer, a robot simulation device, or the like. It is also possible to combine the above embodiments in such a way that after the user program is input, the weight is determined according to the configuration of the first embodiment, and before the input of the user program, the weight is determined according to the configuration of the second embodiment, for example.

In connection with the above embodiments and Modification Examples, the following supplements are further disclosed.

### (Supplement 1)

An adjustment device (10) that adjusts an evaluation function for generating a path of a robot (2) under a prescribed constraint condition, the adjustment device (10) including: a path information acquisition unit (14) that acquires path information that relates to the path of the robot (2) and is specified by a user; and a weight setting unit (15) that sets, based on the path information specified by the user, a weight of an evaluation function for generating the path of the robot (2).

### (Supplement 2)

The adjustment device (10), wherein the path information acquisition unit (14) acquires as the path information a plurality of user programs input by the user, and the weight setting unit (15) sets the weight based on the plurality of user programs.

### (Supplement 3)

The adjustment device (10), wherein the weight setting unit (15) sets the weight common to all of the plurality of user programs so as to prevent difference between the paths of the robot based on the plurality of user programs from increasing.

### (Supplement 4)

The adjustment device (10), further including an output processing unit (13) that outputs information that relates to the weight and is set by the weight setting unit (15).

### (Supplement 5)

The adjustment device (10), further including an output processing unit (13) that outputs a plurality of simulation results for the path of the robot (2) based on a plurality of evaluation functions different in setting of the weight, in which the path information acquisition unit (14) acquires, as the path information, the simulation result specified by the user out of the plurality of output simulation results, and the weight setting unit (15) newly sets a weight based on the weight of the evaluation function corresponding to the simulation result specified by the user.

### (Supplement 6)

The adjustment device (10), wherein the output processing unit (13) outputs a simulation result of the weight newly set by the weight setting unit (15), and the weight setting unit (15) newly sets a weight based on the weight of the evaluation function corresponding to the simulation result re-specified by the user.

### EXPLANATION OF REFERENCE NUMERALS

2 Robot
10 Control device
11 Storage unit
12 Input processing unit
13 Output processing unit
14 Path information acquisition unit
15 Weight setting unit
16 Path generation unit

1. An adjustment device that adjusts an evaluation function for generating a path of a robot under a prescribed constraint condition, the adjustment device comprising:
a path information acquisition unit that acquires path information that relates to the path of the robot and is specified by a user; and
a weight setting unit that sets, based on the path information specified by the user, a weight of the evaluation function for generating the path of the robot.

2. The adjustment device according to claim 1, wherein
the path information acquisition unit acquires as the path information a plurality of user programs input by the user, and
the weight setting unit sets the weight based on the plurality of user programs.

3. The adjustment device according to claim 2, wherein the weight setting unit sets the weight common to all of the plurality of user programs so as to prevent difference between the paths of the robot based on the plurality of user programs from increasing.

4. The adjustment device according to claim 1, further comprising an output processing unit that outputs information that relates to the weight and is set by the weight setting unit.

5. The adjustment device according to claim 1, further comprising an output processing unit that outputs a plurality of simulation results for the path of the robot based on a plurality of evaluation functions different in setting of the weight, wherein
the path information acquisition unit acquires, as the path information, the simulation result specified by the user out of the plurality of output simulation results, and
the weight setting unit newly sets a weight based on the weight of the evaluation function corresponding to the simulation result specified by the user.

6. The adjustment device according to claim 5, wherein the output processing unit outputs a simulation result of the weight newly set by the weight setting unit, and
the weight setting unit newly sets a weight based on the weight of the evaluation function corresponding to the simulation result re-specified by the user.
